(19) United States
(12) Patent Application Publication
(10) Pub. No.: US 2010/0294645 A1
(43) Pub. Date: Nov. 25, 2010

(54) COMBINED SUMP AND INLINE HEATER FOR DISTILLATION SYSTEM

(75) Inventors: William H. Zebuhr, Nashua, NH (US); Arthur E. Ruggles, Billerica, MA (US)

Correspondence Address: FOLEY HOAG, LLP;PATENT GROUP, WORLD TRADE CENTER WEST, 155 SEAPORT BLVD, BOSTON, MA, 02110, US

(73) Assignee: ZanAqua Technologies, Hudson, NH (US)

(21) Appl. No.: 12/469,479

(22) Filed: May 20, 2009

(51) Int. Cl. B01D 3/02; F24H 1/10

(52) U.S. Cl. 203/82; 392/471; 202/167

(57) ABSTRACT

A distillation system for distilling influent liquid includes a counterflow heat exchanger for receiving and heating the influent liquid. A heater is coupled to the counterflow heat exchanger for receiving the influent liquid from the counterflow heat exchanger and heating the influent liquid. An evaporation unit is coupled to the heater and to a sump for receiving the influent liquid from the heater and for receiving liquid from the sump and forming a vapor from at least a portion of the influent liquid and the liquid received from the sump. The evaporation unit returns unevaporated liquid to the sump. A condensation unit is coupled to the evaporation unit for forming a condensate from vapor received from the evaporation unit. The condensation unit is coupled to the counterflow heat exchanger for transferring the condensate to the counterflow heat exchanger. The heater simultaneously heats the liquid in the sump and the influent liquid received from the counterflow heat exchanger.

### FIELD OF THE INVENTION

The present application generally relates to distillers and, more particularly, to a heater for providing supplemental heating in a distiller.

### BACKGROUND OF THE INVENTION

Distillation is the process of purifying a liquid (such as water) or, conversely, producing a concentrate (such as concentrated orange juice). In general, distillation involves heating liquid to be distilled to the point of evaporation, and collecting and condensing the resulting vapor.

U.S. Patent Application Publication No. 2008/0237025 discloses an example of a compact distiller. In such a distiller, the liquid to be distilled is heated to near its boiling temperature and then sprayed onto the heat-exchange surfaces of a rotary heat exchanger forming an evaporation chamber. A compressor draws the resultant vapor from the evaporation chamber, leaving contaminants behind. The compressor raises the vapor's pressure and delivers the higher-pressure (and thus higher-saturation-temperature) vapor to the rotary heat exchanger's condensation chamber. In that chamber, thermal communication with the evaporation chamber results in the vapor condensing into a largely contaminant-free condensate, surrendering its heat of vaporization in the process to the liquid in the evaporation chamber.

Rotary heat exchangers of that type and others are ordinarily operated such that the rate at which the liquid evaporates in the evaporation chamber is only a small fraction of the rate at which it is sprayed onto the heat-exchange surfaces. In many cases, eighty to ninety percent of the sprayer flow remains liquid. The rapidly spinning heat exchange surfaces of the rotary heat exchanger fling the unevaporated liquid by centrifugal force into an annular feed-water sump, which is a small reservoir near the bottom of the distiller. Scoop tubes skim liquid from the sump and route it back to the sprayers, which continue to spray the liquid on the heat exchange surfaces. The distiller therefore needs only to be supplied a small percent, e.g., ten to twenty percent, as much influent liquid at its inlet as is sprayed on its heat-exchange surfaces to make up for evaporation. Drawing in more or less influent liquid than that would ultimately flood or deplete the sump. Accordingly, the influent liquid flow rate into the distiller is regulated to match the evaporation rate and in order to maintain a generally constant volume in the sump.

The influent liquid added to the sump is at a cooler temperature than the liquid in the sump. Liquid from the sump that is sprayed onto the heat exchange surfaces in the evaporation chamber is in a subcooled state. Steam enters the rotary heat exchanger's condensation chamber in a superheated state. The heating of the subcooled liquid in the evaporation chamber should balance the superheated cooling in the condensation chamber to sustain evaporation and condensation levels. The sensible heat of the exit flow from the distiller can be largely recovered through the use of a counterflow heat exchanger to heat the influent liquid. The heat that is not recovered is supplied by supplemental heating. In the steady state (i.e., normal operation) mode, supplemental heat is added to the liquid before it is sprayed on the heat exchange surfaces of the evaporation chamber in order to sustain evaporation.

When the distiller is turned on, liquid in the sump is ordinarily at ambient temperature, and the evaporation rate is accordingly zero. Since there is no evaporation, the influent flowrate is also zero. Heat is therefore added until the liquid in the sump reaches a temperature high enough for distillation. This is referred to as the startup mode of heat addition.

In the standby mode of heat addition, the liquid in the sump is maintained at a somewhat elevated temperature relative to ambient, but still subcooled to the point of no evaporation when the system is turned off. The purpose of the standby mode is to reduce startup time when the distiller is turned on. A heater used in the startup or standby modes operates independently of influent flowrate.

Two separate heaters, an inline heater and a sump heater, have been used in distillation systems to provide heating for the startup, standby, and steady state heating modes. In the steady state mode of operation, supplemental heat is added with the inline heater to heat influent liquid flowing into the distiller. In the startup and standby modes, supplemental heat is added with a separate sump heater for heating liquid in the sump.

### BRIEF SUMMARY OF EMBODIMENTS OF THE INVENTION

A distillation system in accordance with one or more embodiments of the invention includes a heater for heating influent liquid received from an inlet. A sump receives the influent liquid from the heater. An evaporation unit receives liquid from the sump and forms a vapor from at least a portion of the liquid received from the sump. The evaporation unit returns unevaporated liquid to the sump. A condensation unit forms a condensate from vapor received from the evaporation unit. The heater simultaneously heats the liquid in the sump and the influent liquid received from the inlet.

A method of distilling an influent liquid in accordance with one or more embodiments of the invention includes the steps of: transferring influent liquid received at an inlet to a sump; forming a vapor from at least a portion of the liquid received from the sump, and returning unevaporated liquid to the sump; forming a condensate from the vapor; and simultaneously heating the influent liquid received from the inlet prior to the influent liquid being transferred to the sump and the liquid in the sump using a single heater.

A heater in accordance with one or more embodiments of the invention provides supplemental heating in a distillation system. The distillation system includes a sump and an evaporation unit for receiving liquid from the sump and forming a vapor from at least a portion of the liquid received from the sump. The evaporation unit returns unevaporated liquid to the sump. The heater includes a heating element proximate the sump for heating the liquid in the sump, and a structure defining a fluid passage in the proximity of the heating element for flow therethrough of an influent liquid to be distilled. The structure includes a heater inlet for receiving the influent liquid and a heater outlet for transferring the influent liquid from the fluid passage to the sump. The heating element simultaneously heats the liquid in the sump and the influent liquid flowing through the fluid passage.

A compact distillation system is provided in accordance with one or more embodiments of the invention. The distillation system includes an inlet for receiving influent liquid to be distilled. A counterflow heat exchanger is coupled to the inlet for receiving and heating the influent liquid. A heater is coupled to the counterflow heat exchanger for receiving the influent liquid from the counterflow heat exchanger and heating the influent liquid. An evaporation unit is coupled to the heater and a sump for receiving influent liquid from the heater and liquid from the sump and forming a vapor from at least a portion of the influent liquid and the liquid received from the sump. The evaporation unit returns unevaporated liquid to the sump. A condensation unit is coupled to the evaporation unit for forming a condensate from vapor received from the evaporation unit. The condensation unit is coupled to the counterflow heat exchanger for transferring the condensate to the counterflow heat exchanger. The heater simultaneously heats the liquid in the sump and the influent liquid received from the counterflow heat exchanger.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIGS. 1A and 1B are front and rear views, respectively, of the exterior of a distillation unit in accordance with one or more embodiments of the invention.

FIG. 2 is a simplified cross-sectional view of the distillation unit of FIGS. 1A and 1B.

FIG. 3 is a simplified process flow diagram of the distillation unit of FIGS. 1A and 1B.

FIG. 4 is a cross-sectional view of combined sump and inline heater in accordance with one or more embodiments of the invention.

FIG. 5 is an exploded view of the combined sump and inline heater of FIG. 4.

FIG. 6 is an isometric view of the bottom of the combined sump and inline heater of FIG. 4.

### DETAILED DESCRIPTION

The present application is directed to a combined sump and inline heater for providing supplemental heat in a distiller. The heater simultaneously heats influent liquid flowing into the distiller and liquid in the distiller sump. The heater can be used to provide heat in the startup, standby, and steady state heating modes.

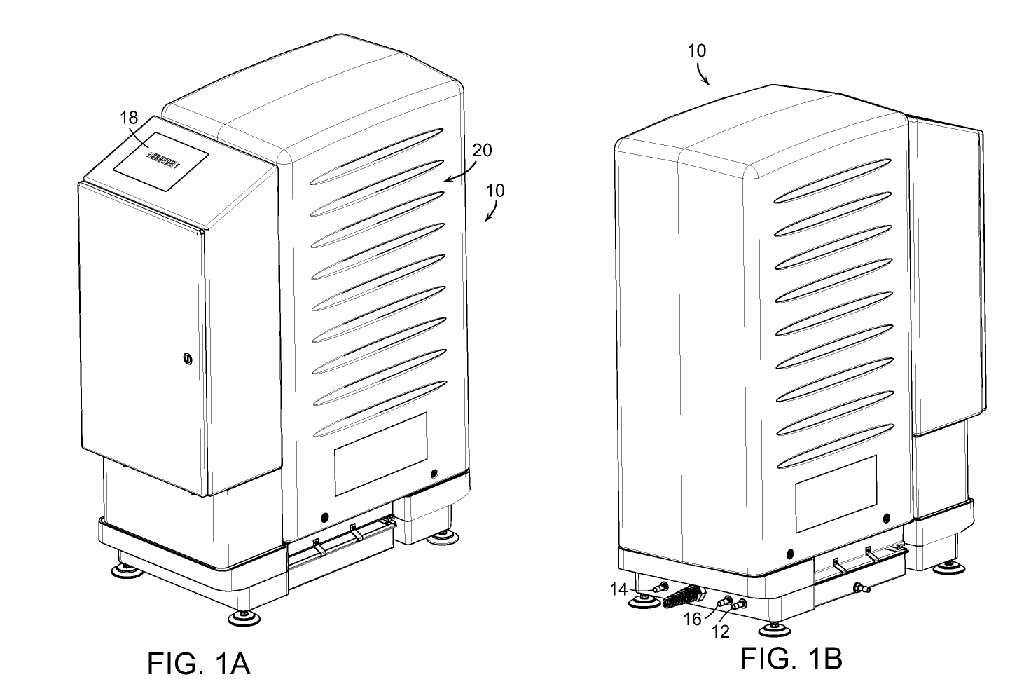

FIGS. 1A and 1B are exterior views of a distillation unit or system 10 having a combined sump and inline heater in accordance with various embodiments of the invention. The distillation unit 10 includes a feed inlet 12 through which the unit 10 draws an influent liquid to be distilled. The distillation unit 10 can be used for various distillation purposes, such as purifying water or condensing liquids like orange juice. For the sake of simplicity, in the exemplary embodiments described herein, the purpose is assumed to be water purification, and the influent liquid is accordingly water that contains contaminants to be removed.

The unit 10 purifies the influent water, producing a generally pure condensate at a condensate outlet 14. The volume rate at which condensate is produced at the outlet 14 will, in most cases, be only slightly less than the rate at which influent water enters inlet 12, with nearly all the remainder being a small stream of concentrated impurities discharged through a concentrate outlet 16.

The distillation unit 10 includes a control unit 18 including a programmable logic controller for controlling operation of the unit 10. A control panel with a keypad and display can be used by an operator to monitor and control operation of the unit 10.

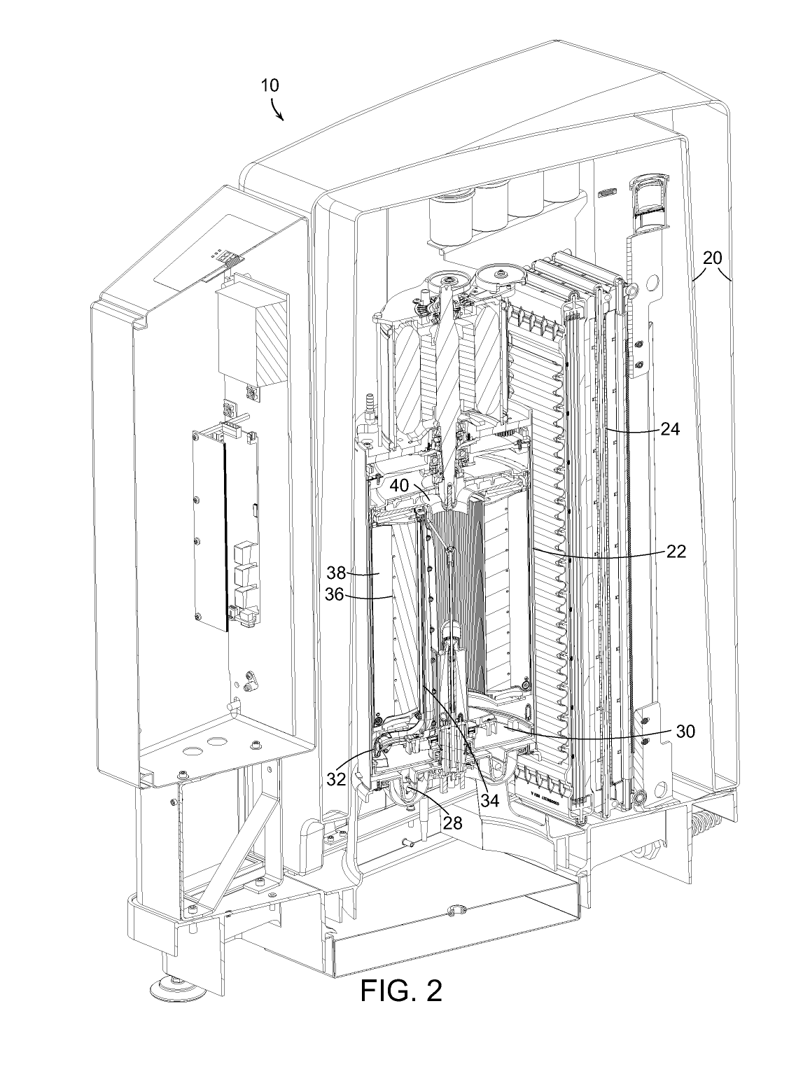

FIG. 2 is a simplified cross-sectional view of the distillation unit 10. The distillation unit 10 includes a housing 20 having an insulated wall preferably made of low-thermal-conductivity material such as polyurethane. The distillation unit 10 includes a distiller 22 and a counterflow heat exchanger 24 located within the housing 20. The counterflow heat exchanger 24 allows heat from fluids exiting the distiller 22 to be largely recovered and transferred to the influent water entering the unit 10.

A feed-water pump, which is not shown and can be outside the housing 20, drives influent water from the feed inlet 12 through the counterflow heat exchanger 24. After being heated by the counterflow heat exchanger 24, the influent water flows through a combined sump and inline heater 28, which is described in further detail below. After flowing through the heater 28, the influent water flows into an annular feed-water sump 30 through set of sprayers 34 as discussed below. As used herein, the term influent water or liquid refers to feed-water or liquid flowing into the combined sump and inline heater 28. The term sump water or liquid refers to water or liquid in the sump 30. Sump water is a mixture of influent water entering the sump 30 through the heater 28 and unevaporated water returned by the evaporation chamber of the distiller 22.

Scoop tubes 32 skim sump water from the sump 30 and direct it to a set of stationary sprayers 34. The sprayers 34 spray the sump water along with influent water from the heater 28 onto the exterior surfaces of the radially extending heat-transfer blades 36 of a rotary heat exchanger 38 forming an evaporation chamber, in which the sprayed water absorbs heat and partially evaporates.

Leaving unevaporated impurities behind, a compressor 40 draws in the resulting vapor and feeds it pressurized into an interior condensation chamber defined by the interior surfaces of the hollow heat transfer blades 36. There, the pressurized water vapor condenses, surrendering its heat of vaporization through the blade walls to the water sprayed on the blades' exterior surfaces.

The condensed water is the purified output of the distiller 22. The counterflow heat exchanger 24 receives that output, cools it by thermal communication with the incoming influent water, and delivers it to the condensate outlet 14 shown in FIG. 1B.

As previously discussed, only some of the sump water and influent water that is sprayed onto the rotary heat exchanger 38 blade exterior surfaces evaporates. In the illustrated embodiment, eighty to ninety percent of the sprayer flow remains liquid. The spinning blades 36 fling this remaining liquid back to the sump 30. The scoops at the sump 30 continue to transfer the sump water back to the sprayers 34.

The flow through the sprayers 34 should be greater than the influent flow entering the sump 30. The influent flow should be only great enough to replenish the evaporated liquid. However, the evaporation rate can vary, and even a slight mismatch between the rates of influent flow and evaporation could eventually either deplete the sump 30 or make its depth so great as to compromise the effectiveness of the rotary heat exchanger 38. A regulator is accordingly provided to control the rate of influent flow such that it matches the evaporation rate.

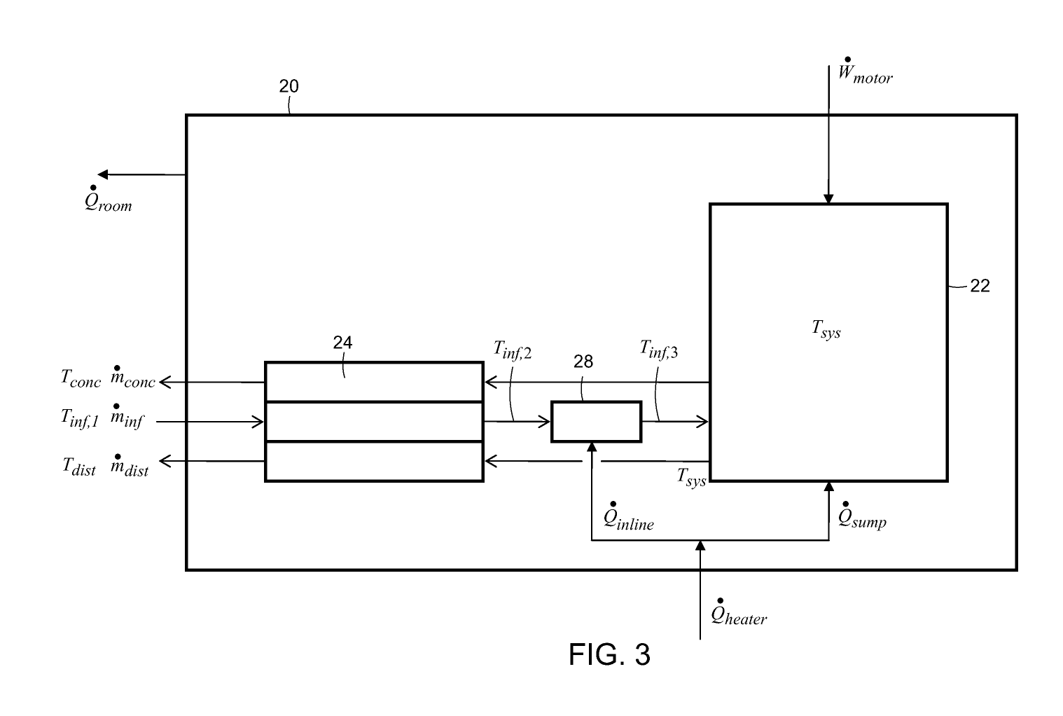

The functions of the combined sump and inline heater 28 are related to the energy recovery of the distillation unit 10 as a whole. FIG. 3 is a simplified process flow diagram of the distillation unit 10, which includes the counterflow heat exchanger 24, heating sources, and the distiller 22 surrounded by the insulated housing 20. Influent water enters the insulated housing 20 at the feed inlet 12 with a mass flowrate \dot{m}_{inf} and a temperature T_{inf 1} (about 70° F.). Distillate water exits the insulated housing 20 at the condensate outlet 14 with a mass flowrate \dot{m}_{dist} and a temperature T_{dist} (about 77° F.). Concentrate water exits the insulated housing 20 at concentrate outlet 16 with a mass flowrate \dot{m}_{conc} and a temperature T_{conc} (about 77° F.). Water exiting the distiller 22 is considered to be at system temperature T_{sys} (about 212° F.). Influent water recovers a percentage of the heat from the exiting distillate and concentrate streams and exits the counterflow heat exchanger 24 at a temperature T_{inf 2} (about 200-205° F.). Since the counterflow heat exchanger 24 effectiveness is less than unity, T_{inf 2}<T_{sys}, supplemental heat \dot{Q}ᵢₙₗᵢₙₑ is added to the influent before entering the sump 30 of the distiller, raising the influent temperature to T_{inf 3} (about 206-209° F.). The distiller 22 receives supplemental heat \dot{Q}ₛᵤₘₚ for directly heating the sump 30 and electrical work \dot{W}ₘₒₜₒᵣ for vapor compression and internal pumping. The supplemental heat \dot{Q}ᵢₙₗᵢₙₑ and \dot{Q}ₛᵤₘₚ is provided by the combined sump and inline heater 28 in accordance with various embodiments of the present invention. Heat is lost from the insulation package to the room at a rate \dot{Q}ᵣₒₒₘ.

In steady state operation, the supplemental heat provided in the distillation unit 10 is given by an energy balance over the insulation package.

\dot{m}_{inf}h_{inf}+\dot{Q}ᵢₙₗᵢₙₑ+\dot{Q}ₛᵤₘₚ+\dot{W}ₘₒₜₒᵣ=\dot{m}_{dist}h_{dist}+\dot{m}_{conc}h_{conc}+\dot{Q}ᵣₒₒₘ

where h is enthalpy. Using continuity and the enthalpy change of an incompressible fluid, the supplemental heat provided is

(\dot{Q}ᵢₙₗᵢₙₑ+\dot{Q}ₛᵤₘₚ)=\dot{m}_{dist}cₚ(T_{dist}−T_{inf})+\dot{m}_{conc}cₚ(T_{conc}−T_{inf})+\dot{Q}ᵢₙₛ−\dot{W}ₘₒₜₒᵣ

The flow energy loss terms are related to counterflow heat exchanger effectiveness, and the insulation energy loss is related to the insulation thermal resistance R value. The overall energy balance does not distinguish between the sump and inline heater functionalities. As previously discussed, a significant function of sump heating is to supply heat during standby and startup modes, and a significant function of the inline heating is to supply heat during sustained steady state distillation.

A combined sump and inline heater 28 in accordance with various embodiments provides the advantages of using both sump and inline heating. One advantage during steady state operation of using both an inline heating and sump heating is that additional venting can be provided after the inline heating. Although not shown in FIG. 3, the influent water passes a number of venting locations along the counterflow heat exchanger 24. The solubility of non-condensable gases such as air in liquid water decreases with increasing temperature. The presence of air in influent water entering the distiller can adversely affect distiller performance. Since the inline heating is provided outside the sump 30 and T_{inf 3}>T_{inf 2}, an additional venting location can be provided after the inline heating. Inline heating also helps avoid thermal fluctuations. As influent water reaches the distiller, if the temperature is significantly less than the system temperature, then in some distiller designs, significant sump mixing may be needed to avoid uneven sump water temperature distribution and system instabilities. Inline heating reduces temperature differences between the influent water and the sump water. In addition, inline heating improves thermal management of hardware. In the distiller 22, the influent is added to the sump by being injected through the nozzles of sprayers 34 and applied directly to the rotary heat exchanger evaporator surfaces where some of it is evaporated and the rest directed to the sump. If all required supplemental heat were to be provided by the sump heater, the influent being applied to the evaporator surfaces would be too cold and heat would be taken from the condensing steam instead of only from the super heat and the effectiveness of the rotary heat exchanger surfaces would be reduced.

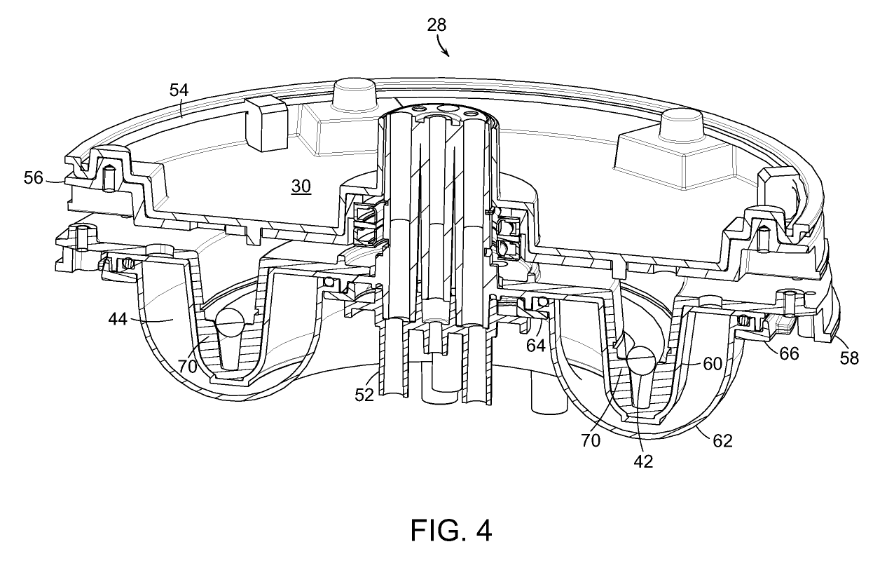

FIGS. 4-6 illustrate an exemplary combined sump and inline heater 28 in accordance with various embodiments of the invention. As shown in the cross sectional view of FIG. 4, the heater 28 includes a single heating element 42 that can simultaneously transfer heat to the influent water flowing through a fluid passage 44 below the heating element 42 as well as to water in the sump 30 above the heating element 42.

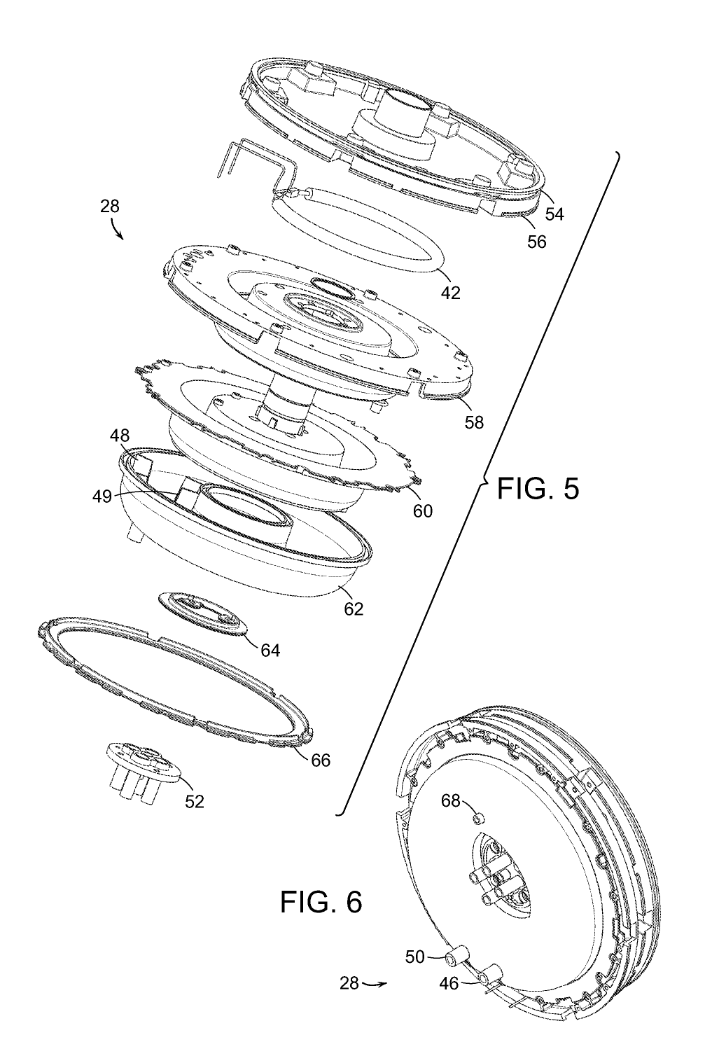

FIG. 5 is an exploded view of the heater 28, and FIG. 6 is isometric view of the bottom of the heater 28.

Influent water enters the heater 28 through an inlet port 50 at the bottom of the heater 28 (shown in FIG. 6) and passes through the fluid passage 44 (shown in FIG. 4) where it is heated by the heating element 42. The influent water exits the fluid passage 44 through an exit port 46 at the bottom of the heater 28 (shown in FIG. 6). The fluid passage 44 includes a dividing wall 48 (shown in FIG. 5) between the inlet port 50 and the exit port 46 such that the influent water is forced to travel generally around the full circumference of the passage 44 to increase exposure to heat from the heating element 42. In addition, a baffle 49 (shown in FIG. 5) is provided in the fluid passage 44 on a side of the exit port 46 opposite the dividing wall 48. The baffle 49, which has a height that is less than the height of the fluid passage 44, forces water flowing through the fluid passage to clear the height of the baffle 49 before exiting through the exit port 46. The presence of the baffle 49 helps clear the fluid passage 44 of pre-existing air in the passage during startup.

After being heated in the fluid passage 44, the influent water is optionally transferred to a vent (not shown), where non-condensable gases such as air can be released. After being degassed, the influent water flows to the sump 30 through one of the tubes in the tube manifold 52. The sump 30 is defined by a sump inner pan 54, which is structurally supported by a sump outer pan 56. A plate endcap 58 supports the heating element 42 as will be described in further detail below.

A post element 60 and an influent pan 62 define the fluid passage 44 therebetween through which influent water flows. The post element 60 is mounted beneath the plate endcap 58.

The heater 28 also includes a bottom inner support ring 64 for supporting the tube manifold 52. A bottom outer support ring 66 is provided for supporting the post element 60 and the influent pan 62.

The heating element 42 is preferably an electrical resistance heater element, which converts electricity into heat. The heating element 42 can comprise a variety of materials, including, e.g., stainless steel and Inconel™ alloys, depending on the desired operating temperature. In this exemplary embodiment, the heating element 42 has a tubular cross section with the diameter of ¼″ to ½″, with a power output ranging from 200 W to 500 W. Because the heating element 42 is not in contact with the influent liquid or the sump water, it is not subject to scale buildup or corrosion, and can be made of less expensive materials.

Structural components of the heater 28 such as the sump outer pan 56, the plate endcap 58, the bottom inner support ring 64, and the bottom outer support ring 66 preferably comprise a die cast metal such as aluminum.

Parts that are in contact with water such as the sump inner pan 54, the post element 60, the influent pan 62, and the tube manifold 52 preferably comprise a corrosion resistant material such as an injection molded plastic, e.g., a liquid crystal polymer (LCP), which protect the aluminum structural components from exposure to water to improve longevity. Thermally, plastic is a poor conductor and a reduced thickness is desired to reduce conduction temperature differentials. Thicknesses for the plastic parts of the heater 28 in this exemplary embodiment range from 0.040″ to 0.100″.

The influent pan 62 is preferably easily removable so that it can be periodically cleaned of scale buildup, and replaced.

The components of the heater 28 can be attached together using fasteners such as screws through the bottom inner 64 and outer 66 support rings, which mate with threads in the plate endcap 58. The die cast metal endcap 58 structurally holds the fasteners under the load of influent water pressure. Thicknesses for the endcap 58 in the heater 28 in this exemplary embodiment can range from 0.060″ to 0.110″.

As shown in FIG. 6, ports are provided at the bottom of the heater 28 including a heater cavity drain 68 for service, the inlet port 50 where influent water enters the fluid passage 44, and the exit port 46 where influent water exits the fluid passage 44.

Heat from the heating element 42 is divided between heat provided to the influent water in the fluid passage 44 and heat provided to water in the sump. The proportion of heat transferred to the influent water and the sump water can be varied through changes in the heater design including, e.g., the manner in which the heating element 42 is supported. The heating element 42 is supported in the plate endcap 58 at discrete, space-apart support locations by conduction contacts 70 (shown in FIG. 4) positioned on the post element 60. In the exemplary embodiment, there are four conduction contacts 70 generally equally spaced around the circumference of the post element 60. Heat is transferred from the heating element 42 by a combination of heat conduction through the conduction contacts 70, by convection through the air surrounding the heating element 42 (a relatively weaker heat transfer mode), and by radiation. If the conduction contact area (i.e., the surface of the conduction element in contact with the heating element 42) is relatively large, then the heat transfer from the element can be mostly via conduction, and the influent water in the fluid passage 44 receives the most of the heat. If on the other hand, the conduction contact area is small, then the heat transfer from the heating element 42 can be mostly via radiation. This leads to a higher heating element surface temperature. In this case, the proportion of heat to the influent water is controlled by the radiation view factor to the endcap 58. The surface temperatures of the heating element 42 and surrounding parts can be controlled by the radiation surface areas, view factors, and surface emissivities.

The proportion of heat from the heating element 42 transmitted to the influent water and the sump water can also be controlled through the design of the fluid passage geometry, particularly the flow area of the fluid passage 44. In the exemplary embodiment, the average spacing between the plastic walls defining the fluid passage 44 ranges from 0.2″ to 1.0″. The particular spacing affects the convection heat transfer to the water. At a given flowrate, the cross sectional area sets the velocity by continuity

$$V = \frac{{\dot{m}}_{inf}}{ρ A}$$

where ρ is the density of water. The flow regime is determined by the Reynolds number

$$Re = \frac{ρ {VD}_{h}}{μ}$$

where μ is the viscosity of water and Dₕ is the hydraulic diameter (roughly twice the fluid passage gap height). The Nusselt number in general reads

$$Nu ( Re , Pr ) = \frac{{hD}_{h}}{k} ⇒ h = \frac{Nu ( Re , Pr ) k}{{D}_{h}}$$

where h is the heat transfer coefficient, k is the thermal conductivity of water, and Pr is the Prandtl number of water. As hydraulic diameter decreases, the heat transfer coefficient increases. Convection heat transfer to the water (boiling considerations aside) is given by

\dot{Q}_{inf}=hA_{conv}(T_{plastic}−T_{water})

where A_{conv} is the inner surface area of the fluid passage 44. T_{water} in the above expression is an average temperature since the exiting water temperature will be higher the entering water temperature. To reduce the convection temperature difference, the convection area or the heat transfer coefficient is increased. The convection coefficient can be increased by decreasing the hydraulic diameter via the fluid passage gap spacing.

Manufacturing tolerances in the endcap 58 and post element 60 may result in the presence of a space between the parts. The spacing, which can be about 0.002″, may behave as an insulating air gap. The elevated thermal resistance resulting from the air gap can lead to elevated endcap and post element 60 temperatures, and can adversely affect heater performance. The air gap can be substantially eliminated by the use of a thermally conductive filler such as a thermal grease or paste between the parts.

The programmable logic controller of the control unit 18 can be used to control power supplied to the heating element 42 to control operation of the heater 28. Heater operation can be controlled when the system is turned on, off, or placed in a standby mode. The programmable logic controller can also shut down the heater 28 for safety reasons if the heater element temperature or water temperature becomes too high. Additionally, the supplemental heat provided by the heater 28 can be adjusted if the temperature of the influent water entering the unit 10 increases or decreases during operation. Temperature sensing devices such as thermocouples can be used to monitor the temperature of the heating element 42, influent water, and/or sump water. The programmable logic controller can control the heater 28 based on temperature readings from the thermocouples.

It is to be understood that although the invention has been described above in terms of particular embodiments, the foregoing embodiments are provided as illustrative only, and do not limit or define the scope of the invention. Various other embodiments are also within the scope of the claims. For example, elements and components described herein may be further divided into additional components or joined together to form fewer components for performing the same functions.

1. A distillation system, comprising:
a heater for heating influent liquid received from an inlet;
a sump for receiving the influent liquid from the heater;
an evaporation unit for receiving liquid from the sump and forming a vapor from at least a portion of the liquid received from the sump, the evaporation unit returning unevaporated liquid to the sump; and
a condensation unit for forming a condensate from vapor received from the evaporation unit;
wherein the heater simultaneously heats the liquid in the sump and the influent liquid received from the inlet.

2. The distillation system of claim 1, further comprising a vent for degassing influent liquid from the heater prior to transfer of the influent liquid to the sump.

3. The distillation system of claim 1, further comprising a counterflow heat exchanger for transferring heat from the condensate to the influent liquid entering the distillation system from the inlet.

4. The distillation system of claim 1, wherein the evaporation unit and the condensation unit comprise a rotary heat exchanger having a plurality of rotating blades, and wherein an evaporation chamber is defined by exterior surfaces of the rotating blades, and a condensation chamber is defined by interior surfaces of the rotating plates.

5. The distillation system of claim 1, wherein the heater includes an electrical resistance heating element and a fluid passage in the proximity of the heating element such that influent liquid is heated by the heating element as the influent liquid passes through the fluid passage.

6. The distillation system of claim 5, wherein surfaces defining the fluid passage comprise a corrosion resistant material.

7. The distillation system of claim 5, further comprising a plurality of conduction contacts for supporting the electrical resistance heating element and transferring heat from the heating element to influent liquid in the fluid passage primarily by heat conduction.

8. The distillation system of claim 5, wherein the heating element transfers heat to liquid in the sump primarily by radiation heating.

9. The distillation system of claim 1, wherein the heater comprises an electrical resistance heating element, and wherein the distillation system further comprises one or more thermocouples to determine one or more temperature conditions, and a controller responsive to the one or more temperature conditions for controlling power supplied to the electrical resistance heating element.

10. The distillation system of claim 1, wherein the heater comprises a heating element proximate the sump for heating the liquid in the sump, and a structure defining a fluid passage in the proximity of the heating element for flow therethrough of the influent liquid to be distilled, said structure including a heater inlet for receiving the influent liquid and a heater outlet for transferring the influent liquid from the fluid passage to the sump.

11. The distillation system of claim 10, wherein the fluid passage has an annular configuration, and further comprises an obstruction therein between the heater inlet and the heater outlet for causing the influent liquid to travel a given distance through the fluid passage.

12. The distillation system of claim 11, further comprising a baffle in the fluid passage for causing the influent liquid to travel over the baffle prior to exiting the fluid passage through the heater outlet.

13. The distillation system of claim 10, wherein the structure defining the fluid passage comprises an influent pan, said influent pan being removable for cleaning.

14. The distillation system of claim 1 wherein the evaporation unit receives the influent liquid from the heater, forms a vapor from at least a portion of the influent liquid and liquid received from the sump, and transfers unevaporated liquid to the sump.

15. A method of distilling an influent liquid, comprising:
transferring influent liquid received at an inlet to a sump;
forming a vapor from at least a portion of the liquid received from the sump, and returning unevaporated liquid to the sump;
forming a condensate from the vapor; and
simultaneously heating the influent liquid received from the inlet prior to the influent liquid being transferred to the sump and the liquid in the sump using a single heater.

16. The method of claim 15, further comprising degassing the influent liquid after heating the influent liquid and prior to transfer of the influent liquid to the sump.

17. The method of claim 15, further comprising transferring heat from the condensate to the influent liquid from the inlet prior to simultaneously heating the influent liquid and the liquid in the sump.

18. The method of claim 15, wherein simultaneously heating the influent liquid received from the inlet and the liquid in the sump using a single heater comprises flowing the influent liquid past a heating element proximate the sump while the influent liquid flows to the sump.

19. The method of claim 15, wherein simultaneously heating the influent liquid received from the inlet and the liquid in the sump comprises heating the influent liquid primarily by conductive heating and heating the liquid in the sump primarily by radiation heating.

20. The method of claim 15, further comprising monitoring temperature conditions and controlling heating of the influent liquid and liquid in the sump accordingly.

21. A heater for providing supplemental heating in a distillation system, the distillation system including a sump and an evaporation unit for receiving liquid from the sump and forming a vapor from at least a portion of the liquid received from the sump, the evaporation unit returning unevaporated liquid to the sump, the heater comprising:
a heating element proximate the sump for heating the liquid in the sump; and
a structure defining a fluid passage in the proximity of the heating element for flow therethrough of an influent liquid to be distilled, said structure including a heater inlet for receiving the influent liquid and a heater outlet for transferring the influent liquid from the fluid passage to the sump;
wherein the heating element simultaneously heats the liquid in the sump and the influent liquid flowing through the fluid passage.

22. The heater of claim 21, further comprising a plurality of conduction contacts for supporting the heating element in said structure and transferring heat from the heating element to influent liquid in the fluid passage primarily by heat conduction.

23. The heater of claim 21, wherein the heating element heats the liquid in the sump primarily by radiation heating and heats the influent liquid primarily by conductive heating.

24. The heater of claim 21, wherein the fluid passage has an annular configuration, and further comprises an obstruction therein between the heater inlet and the heater outlet for causing the influent liquid to travel a given distance through the fluid passage.

25. The heater of claim 24, further comprising a baffle in the fluid passage for causing the influent liquid to travel over the baffle prior to exiting the fluid passage through the heater outlet.

26. The heater of claim 21, further comprising one or more thermocouples to determine one or more temperature conditions in the heater, and wherein power supplied to the heating element can be controlled responsive to the one or more temperature conditions.

27. The heater of claim 21, wherein the structure defining a fluid passage comprises an influent pan, said influent pan being removable for cleaning.

28. The heater of claim 21, wherein surfaces of the structure in contact with the influent liquid comprise a corrosion resistant material.

29. A compact distillation system, comprising:
an inlet for receiving influent liquid to be distilled;
a counterflow heat exchanger coupled to the inlet for receiving and heating the influent liquid;
a heater coupled to the counterflow heat exchanger for receiving the influent liquid from the counterflow heat exchanger and heating the influent liquid;
a sump;
an evaporation unit coupled to the sump and the heater for receiving liquid from the sump and the influent liquid from the heater and forming a vapor from at least a portion of the liquid received from the sump and the influent liquid from the heater, the evaporation unit returning unevaporated liquid to the sump; and
a condensation unit coupled to the evaporation unit for forming a condensate from vapor received from the evaporation unit, said condensation unit coupled to the counterflow heat exchanger for transferring the condensate to the counterflow heat exchanger;
wherein the heater simultaneously heats the liquid in the sump and the influent liquid received from the counterflow heat exchanger.

30. The compact distillation system of claim 29, wherein the heater comprises a heating element proximate the sump for heating the liquid in the sump, and a structure defining a fluid passage in the proximity of the heating element for flow therethrough of the influent liquid to be distilled, said structure including a heater inlet for receiving the influent liquid and a heater outlet for transferring the influent liquid from the fluid passage to the sump.

31. The compact distillation system of claim 30, wherein the heating element heats the influent liquid primarily by conductive heating and heats the liquid in the sump primarily by radiation heating.
